(19) United States
(12) Patent Application Publication
(10) Pub. No.: US 2025/0392530 A1
(43) Pub. Date: Dec. 25, 2025

(54) REMOTE DIAGNOSTIC SYSTEM, METHOD AND APPARATUS FOR ELECTRONIC DEVICES

(71) Applicant: Trident IoT, LLC, Carlsbad, CA (US)

(72) Inventors: Lewis Clay Dearman, Taylor, TX (US); Michael Archbold, Asheville, NC (US)

(21) Appl. No.: 19/076,074

(22) Filed: Mar. 11, 2025

Related U.S. Application Data
(63) Continuation of application No. 18/784,196, filed on Jul. 25, 2024, now abandoned.
(60) Provisional application No. 63/663,507, filed on Jun. 24, 2024.

(51) Int. Cl. H04L 43/0817; H04L 12/28; H04L 12/46; H04L 41/22

(52) U.S. Cl. CPC H04L 43/0817; H04L 12/2854; H04L 12/4633; H04L 41/22

(57) ABSTRACT

A system, method and apparatus is described for enabling remote diagnostics of an electronic device installed in the field. Remote diagnostic commands from a remote computer system are received by a hub, where they are placed into a payload of an encapsulated message, and then transmitted to an electronic device in accordance with a standardized, local-area wireless communication protocol. The electronic device receives the encapsulated message and executes the remote diagnostic command in the payload in accordance with a custom extension to the standardized, local-area wireless communication protocol. A response to the remote diagnostic command is placed into a payload of another encapsulated message and then transmitted to the hub. The hub retrieves the diagnostic response in the payload and constructs a diagnostic response network packet in accordance with the extension and sends the diagnostic response network packet to the remote computer system.

### CROSS-REFERENCE TO RELATED APPLICATIONS

The present application is a continuation of U.S. patent application Ser. No. 18/784,196 filed on Jul. 25, 2024, which claims the benefit of U.S. provisional application No. 63/663,507, filed on Jun. 24, 2024.

### BACKGROUND

### Field of Use

The present application relates generally to consumer-grade electronics in general and more specifically to various embodiments of a system, apparatus and method for remotely diagnosing electronic devices.

### Description of the Related Art

The Internet-of-Things (“IoT”) is a buzzword that describes the recent proliferation of small, battery-powered electronic devices, such as security sensors, environmental sensors, HVAC sensors, power sensors, water sensors, temperature sensors, etc. Such IoT sensors typically utilize wireless, low-power communication technology and protocols, such as Z-wave, Zigbee, Thread, Matter, Bluetooth, etc.

One of the challenges of developing such IoT sensors to estimate how such sensors will perform after they have been installed at an end-user location, based on a number of potential factors such as RF interference from other electronic devices, physical interference (such as walls, furniture, construction materials, variations in home/office layouts), variations in temperature and humidity, RF range limitations of a chosen communication technology/protocol, etc. While engineers strive to develop IoT products that will work correctly in any environment, often this is not the case, due to the large number of aforementioned, variable factors that may influence device performance.

After an IoT device has been sold to an end-user and installed in a home or business, it may fail to operate as intended. In order to determine why the device failed, it may be removed and shipped back to a manufacturer for testing. However, the device may not exhibit the same failure, because the failure may be due to one or more aspects of the environment in which the device was installed. Moreover, re-creating the same or similar physical environment is difficult or impossible to achieve.

### SUMMARY

Embodiments of the present invention are directed towards systems, methods and apparatus for enabling remote diagnostics of an electronic device installed at an end-user location. In one embodiment, a system is described, comprising a hub located at the end-user location, communicably coupled to a computer system via a wide-area network, configured to receive a remote diagnostic command from the computer system over the wide-area network, to construct a first encapsulated message comprising a payload field comprising the remote diagnostic command, and to transmit the first encapsulated message to the electronic device in accordance with the standardized, local-area wireless communication protocol, and the electronic device, configured to receive the first encapsulated message, to execute the remote diagnostic command in the payload in accordance with an extension of the standardized, local-area wireless communication protocol, to perform a diagnostic function associated with the remote diagnostic command in accordance with the extension, to obtain a diagnostic response from performing the diagnostic function, to construct a second encapsulated message comprising the diagnostic response and to transmit the second encapsulated message to the hub.

In another embodiment, a method is described, for enabling remote diagnostics of an electronic device installed at an end-user location, comprising receiving, by a hub located at the end-user location, a remote diagnostic command from a computer system over a wide-area network, constructing, by the hub, a first encapsulated message in accordance with a standardized, local-area wireless communication protocol used by the hub to communicate with the electronic device, the encapsulated message comprising the remote diagnostic command in a payload of the first two here encapsulated message, transmitting, by the hub, the first encapsulated message to the electronic device in accordance with the standardized, local-area wireless communication protocol, receiving, by the electronic device, the first encapsulated message, executing the payload in accordance with an extension of the standardized, local-area wireless communication protocol, performing a diagnostic function associated with the remote diagnostic command in association with the extension, obtaining a diagnostic response from performing the diagnostic function, constructing a second encapsulated message comprising the diagnostic response and transmitting the second encapsulated message to the hub.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1A is a block diagram illustrating prior art circuitry used to develop and debug an electronic device;

FIG. 1B is a block diagram illustrating one embodiment of the present invention;

FIG. 2 is a block diagram of a system for enabling remote diagnostics of an electronic device installed at an end-user location;

FIG. 3 is a functional block diagram of one embodiment of one of the electronic devices as shown in FIG. 1B and FIG. 2, configured to execute remote diagnostic commands;

FIG. 4 is a functional block diagram of one embodiment of a hub as shown in FIG. 2, configured to provide operational functionality to the system shown in FIG. 2 as well as to support remote diagnostics of the electronic devices shown in FIG. 2; and

FIGS. 5A, 5B and 5C represent a flow diagram illustrating one embodiment of a method for enabling remote diagnostics of the electronic devices shown in FIG. 2.

### DETAILED DESCRIPTION

Embodiments of a system, method and apparatus for enabling remote diagnostics of electronic devices are described. In one embodiment, remote diagnostics are performed using a remote command-line interface (rCLI) protocol that provides a text-based interface to an electronic device installed remotely from a diagnostic computer system. This allows engineers to diagnose and potentially develop electronic devices while they are installed at end-users' homes or businesses. As used herein, the term “diagnostic computer system” may refer to a computer system used to develop and/or diagnose electronic devices. Such remote diagnosis and/or development may comprise remotely exercising electronic devices using diagnostic and functional commands. Such diagnostics may comprise retrieving data stored by an electronic device, test interactions with other electronic devices in the same network, injecting commands into the network for verifying message routing, retrieving register values, etc.

A diagnostic computer located remotely from an electronic device is used to send remote diagnostic commands over a wide-area network to a local hub where an electronic device is co-located. The remote diagnostic commands are received by the local hub and repackaged into “encapsulated” messages in accordance with a standardized, local-area wireless communication protocol used by the hub and the electronic device. Encapsulated messages are defined by the standard, local-area wireless communication protocol, comprising a command executable by the standard local-area wireless communication protocol and a payload field containing a custom command (or response) that is not executable by the standard local-area wireless communication protocol. Rather, these encapsulated commands are executable by a custom “extension” to a standardized, local-area wireless communication protocol, i.e., custom computer code to interpret and perform a number of custom remote commands, as will be explained in more detail later herein.

In response to receiving remote diagnostic commands from the diagnostic computer, encapsulated messages are generated by the hub, each comprising a command section and a payload section comprising a remote diagnostic command. Encapsulated messages are then sent by the hub to an electronic device registered with the hub via the standard, local-area wireless communication protocol.

Electronic devices receive encapsulated messages sent from the hub and execute the remote diagnostic command contained in each payload section in accordance with the custom extension. The electronic device obtains a diagnostic response in response to executing the remote diagnostic command, and packages it into another encapsulated message, placing the diagnostic response in the payload, and then transmitting the encapsulated message to the hub. The hub receives the encapsulated message, retrieves the diagnostic response from the payload, and constructs a network-based diagnostic response packet comprising the diagnostic response and sends it over the wide-area network to the diagnostic computer for display by the diagnostic computer.

Enabling remote diagnostics is a departure from the prior art which, heretofore, allowed debugging and development only locally via a hardwired interface (such as USB, I2C, JTAG, etc.), using a “shell” client that allows communications directly with an electronic device via the hardwired interface. The shell client may utilize a command-line interface protocol, which is a well-known communication technique typically based on text-based commands and responses. However, it is often desirable to perform diagnostics on a device after it has been installed in the field, especially using a command-line interface. This is not technically feasible today in the prior art.

Embodiments of the present invention solve this long-felt need by providing a remote diagnostic interface to an electronic device located remotely from a diagnostic computer, allowing developers to perform diagnostic routines remotely. In one embodiment, a custom extension of a standardized, local-area wireless communication protocol is defined by a developer or manufacturer of an electronic device that allows remote diagnostics of electronic devices as if they were connected directly to a diagnostic computer via a hardwired interface.

A further technological benefit of the ideas presented herein is that an I/O pin of a processor of an electronic device may be freed up to support other device functionality.

Yet another technological benefit of the ideas presented herein is that in many embodiments, no changes are needed to a shell client operating on a diagnostic computer in order to remotely diagnose an electronic device. In one embodiment, engineers may enter command-line interface commands into a shell client just as if an electronic device was hard-wired to the diagnostic computer.

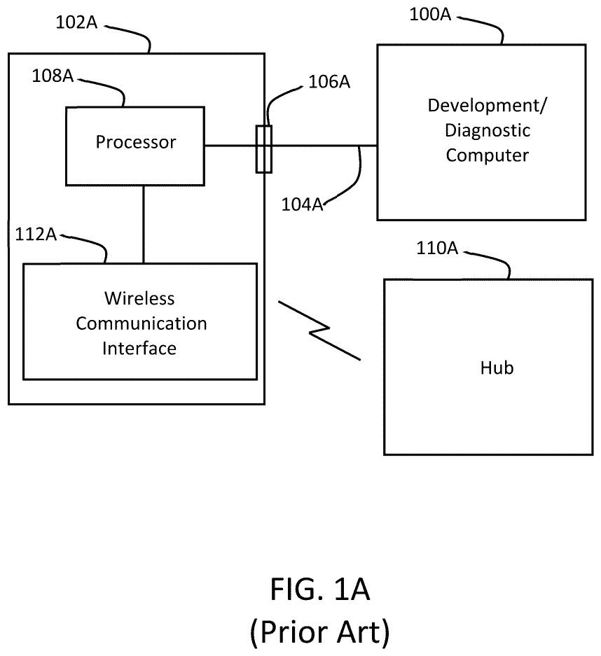

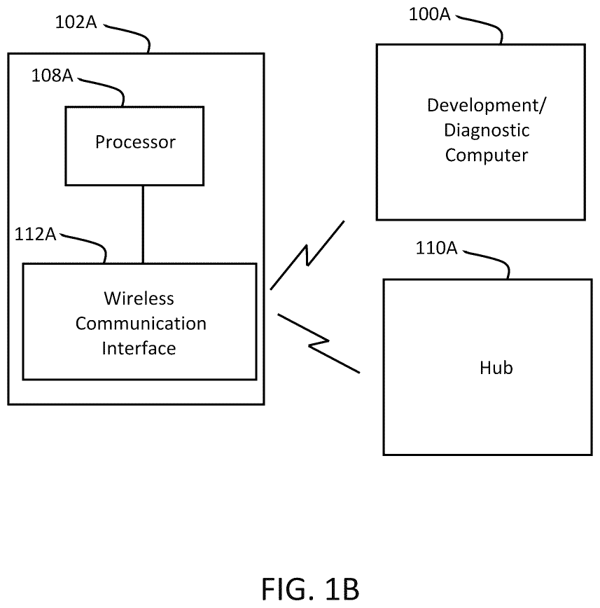

FIG. 1A is a block diagram illustrating prior art circuitry used to develop and debug an electronic device. Shown is development/diagnostic computer 100A coupled to electronic device 102A via an interface cable 104A and a hardwired connector 106A to an I/O port of processor 108A. A text-based, command-line interface protocol may be defined and used to communicate with electronic device 102A, as is well-known in the art. After installing electronic device 102A in the field, electronic device 102A communicates wirelessly with hub 110A using wireless communication interface 112A and a standardized, local-area wireless communication protocol, such as Zwave or Zigbee. I/O port of processor 108A is reserved for communications with development/diagnostic computer 100A during local development and debugging but is typically disabled in production units. Thus, the I/O port remains unavailable for other uses during normal operation.

FIG. 1B is a simplified block diagram illustrating one embodiment of the present invention. Shown is development/diagnostic computer 100A coupled to electronic device 102A via wireless communication interface 112A. In one embodiment, the same text-based commands used in the prior art are used to develop and/or diagnose electronic device 102A, located remotely from development/diagnostic computer 100A. In this arrangement, the text-based commands are sent from development/diagnostic computer 100A over a wide-area network to hub 110A where a target electronic device 102A is co-located. Hub 110A receives the text-based commands, constructs encapsulated messages with text-based commands in a payload section of the encapsulated messages, respectively, and then sends the encapsulated messages to electronic device 102A. Electronic device 102A receives the encapsulated messages and executes the text-based command in each payload. Electronic device 102A then sends encapsulated messages back to hub 110A with diagnostic responses in the payload section of each encapsulated messages, respectively. Hub 110A receives the encapsulated messages from electronic device 102A, and executes the payload, in this case, forming a network-based response packet for transmission to development/diagnostic computer 100A.

The benefit of this inventive arrangement is that it frees up an I/O port of processor 108A of electronic device 102A-diagnostic commands are now received via wireless communication interface 112A vs. hardwired connector 106A, and so the I/O port is free to be used for other functionality. This represents a long-sought technological improvement to electronic devices. In addition, this arrangement may not necessitate changes to a shell client used by development/diagnostic computer 100A for communicating with an electronic device.

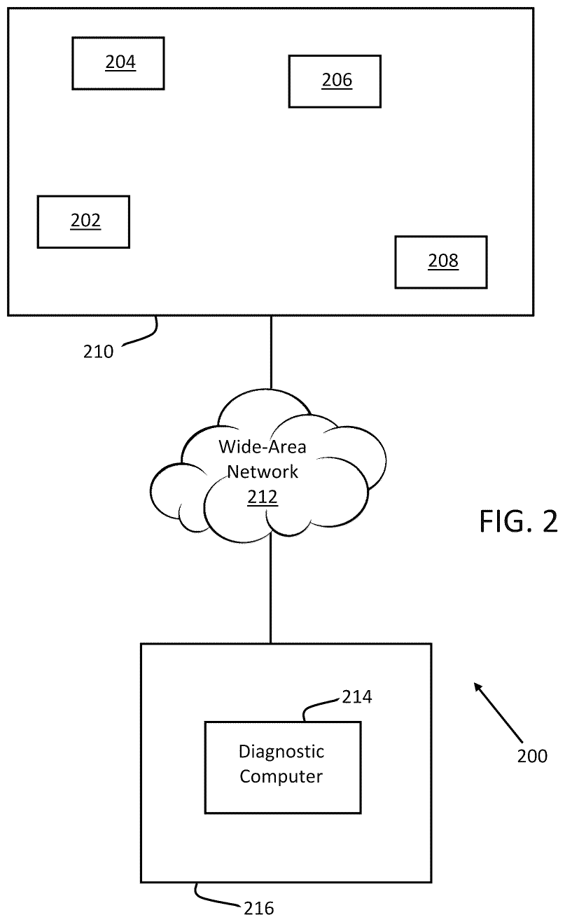

FIG. 2 is a block diagram of a system 200 for enabling remote diagnostics of an electronic device. Shown are three electronic devices 202, 204 and 206 in wireless communication with a local hub 208, all inside a structure 210, such as a home or a business. Hub 208 is coupled to wide-area network 212, allowing hub 208 to communicate with a remote diagnostic computer system 214 located inside structure 216 typically located many tens, hundreds or even thousands of miles away from structure 210. Diagnostic computer system 214 is used by a developer or an engineer to develop or troubleshoot the electronic devices located remotely from computer system 214 inside structure 210.

Electronic devices 202, 204 and 206 each typically comprises a wireless, battery-powered, consumer-grade device installed in various locations of structure 210, for providing security, remote appliance control, remote HVAC control, remote surveillance and other Internet of Things (IoT) services. For example, electronic device 202 may comprise a wireless security door sensor, electronic device 204 may comprise a wireless door lock and electronic device 206 may comprise a smart thermostat. While only three electronic devices are shown in FIG. 2, typically many more electronic devices are deployed in structures, providing similar or additional IoT services.

Each of the electronic devices communicates wirelessly with hub 208 using a standardized, local-area wireless communication protocol that provides direct or indirect communications with hub 208. At least some of the electronic devices may receive remote diagnostic commands from diagnostic computer system 214 via wide-area network 112 and hub 208 and, in response, provide diagnostic responses to diagnostic computer system 214 via hub 208 and wide-area network 112. Diagnostic commands may comprise commands that cause an electronic device to report a status, condition or attribute of an electronic device, or its surrounding environment, cause an electronic device to execute diagnostic code as part of an extension to a standardized, local-area wireless communication protocol, cause an electronic device to execute functional operations (i.e., to transmit a message to another electronic device, to obtain another devices routing table or other operating information, etc.). Diagnostic responses comprise results of executing diagnostic commands, for example, a status, condition or attribute of an electronic device, the results of running hardware diagnostics, values of RF noise experienced by an electronic device, values of registers, values of counters, how many times a device has rejoined a local network, etc. Diagnostic response may, in some embodiments, also comprise “functional” responses, such as a status of a door or window (i.e., open vs. closed), a temperature reading of a thermostat, a status of a security system, etc.

Hub 208 provides a communication interface to the electronic devices within structure 200, allowing users to control the electronic devices via functional commands that are routed to the electronic devices via hub 208, and to receive information from the electronic devices, also via hub 208. Examples of hub 208 comprise a SmartThings® hub, a Ring® security hub, a Vivint® smart hub, etc.

The electronic devices and hub 208 communicate with each other using a standardized, local-area wireless communication protocol. Such standardized wireless communication protocols may comprise wireless mesh protocols, such as the well-known Zwave® and Zigbee® wireless mesh protocols, or may alternatively comprise a point-to-point wireless communication protocol, such as Bluetooth, Bluetooth LE, Wi-Fi, etc.

Each standardized, local-area wireless communication protocol is defined by a number of functional commands and responses which govern normal, functional operation of each electronic device, i.e., to perform an inherent function of each electronic device. For example, in a mesh network topology using the Zwave protocol, each electronic device receives wireless commands, executes the commands and transmits wireless responses, all in accordance with the Zwave protocol. The commands and responses are typically formatted as “data packets” or simply, “packets”, commonly used in modern network topologies. An electronic device's normal, functional operation or inherent function is defined as a function of an electronic device as it operates within system 200. For example, an inherent function of a motion sensor is to detect motion, an inherent function of a thermostat is to control the ambient air temperature, an inherent function of a wireless light bulb is to remotely operate the wireless light bulb.

Most standardized, local-area wireless communication protocols allow developers and manufacturers to add further functionality to a standardized, local-area wireless communication protocol by allowing them to define custom commands that “extend” the functionality of a standardized, local-area wireless communication protocol. This may be accomplished by defining “nested” or “encapsulated” messages that carry custom commands and responses in a payload section of such encapsulated messages. The extension comprises computer code that works in tandem with the standardized computer code of a standardized, local-area wireless communication protocol.

Encapsulated messages typically comprise a command field and a payload field, where the payload field comprises a custom message, such as a diagnostic command or a diagnostic response, and the command field identifies the payload as a custom message defined by the extension. Typically, custom commands and responses in the past have focused on adding functional capabilities to electronic devices, such as an ability for a user to change the way an LED of a motion sensor blinks when motion is detected. In the present context however, custom diagnostic commands and responses are used to remotely develop and/or diagnose electronic devices in the field. When an encapsulated message comprises a remote diagnostic command in its payload, the encapsulated message may be referred to herein as an “encapsulated remote diagnostic command”. Similarly, when an encapsulated message comprises a diagnostic response in its payload, the encapsulated message may be referred to herein as an “encapsulated diagnostic response”.

Remote diagnostic commands are generated by diagnostic computer system 214, transported over wide-area network 212 to hub 208, where they are retrieved and repackaged as payloads of encapsulated messages. The encapsulated messages are then transported over the air to one or more of the electronic devices in system 200. When an electronic device receives such an encapsulated message, it executes the remote diagnostic command in the payload in accordance with the extension, as if the remote diagnostic command had been received locally via a wired interface of an electronic device.

In response to executing the diagnostic command, the electronic device performs a diagnostic function in accordance with the extension. After the diagnostic function has been completed, the electronic device obtains a result of executing the diagnostic function and creates an encapsulated message comprising the diagnostic response in the payload in accordance with the extension. The encapsulated message is then transmitted by the electronic device to hub 208 in accordance with the standardized, local-area wireless communication protocol used by the electronic device and hub 208.

When hub 208 receives the encapsulated message, it identifies the packet as an encapsulated message in accordance with the particular local-area wireless communication protocol in use, retrieves the diagnostic response from the payload, and repackages the diagnostic response in a format suitable for transport over wide-area network 212, typically in the form of one or more TCP/IP data packets, in accordance with the extension. The diagnostic response is received by diagnostic computer system 214, where it retrieves the diagnostic response and displays the diagnostic response to a user of diagnostic computer system 214 on a display device of diagnostic computer system 214.

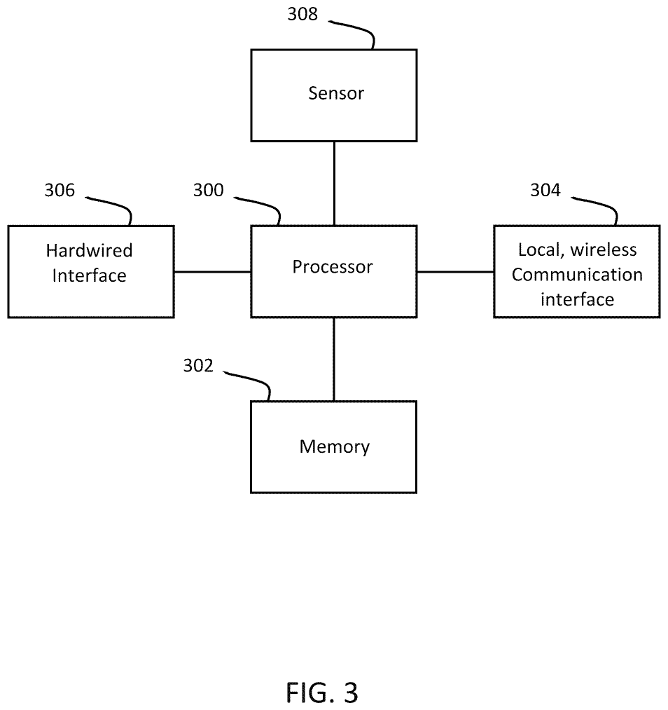

FIG. 3 is a functional block diagram of one embodiment of one of the electronic devices as shown in FIG. 2, configured to receive and execute remote diagnostic commands. FIG. 3 shows processor 300, memory 302, local wireless communication interface 304, hardwired interface 306 and sensor 308. It should be understood that, in some embodiments, the functional blocks may be connected to one another in a variety of ways and that not all functional blocks are necessary for operation of an electronic device (such as a power supply), for purposes of clarity.

Processor 300 is configured to provide operational functionality of an electronic device in accordance with an electronic device type, as well as to provide a remote diagnostic functionality. Such operational functionality and diagnostic functionality are provided as processor 300 executes processor-executable instructions stored in memory 302, for example, executable firmware. Operational functionality may exclude diagnostic functionality. However, in some embodiments, some functional operations of an electronic device may overlap with diagnostic functionality, such as reporting a status of an environment monitored by an electronic device (such as reporting and opened/closed status of a door monitored by a wireless door sensor), performing a functional operation (such as turning a light on or off), etc. Processor 300 typically comprises one or more programmable microprocessors, microcomputers, microcontrollers, custom ASICs, System-on-Chips (SoCs), System-in-Packaging (SiP), or the like, and where two or more processors are used, each of the processors, either alone or in combination, may execute one or more of the processor-executable instructions that cause the processor to perform various functions. Processor 300 may be selected based on a variety of factors, including power-consumption, size, and cost.

Memory 302 is coupled to processor 300, comprising one or more information storage devices, such as RAM, ROM, flash memory, or some other type of electronic, optical, or mechanical memory device(s). Memory 302 is used to store processor-executable instructions for functional operations and diagnostic operations of an electronic device, as well as any information used by processor 300 during functional or diagnostic operations, such as routing tables, RSSI values, register values, counter values, addressing information of hub 208 and other electronic devices, status information, etc. In some embodiments, the processor-executable instructions comprise functional processor-executable instructions used to carry out functional operation of an electronic device, separable from diagnostic processor-executable instructions used to carry out diagnostic operations. In any case, the processor-executable instructions may comprise a custom extension of a well-known wireless communication protocol, such as Zwave or Zigbee. The custom extension defines formats for remote diagnostic commands and diagnostic responses and defines how processor 300 executes the remote diagnostic commands and responses. In one embodiment, the extension comprises a remote command-line interface protocol, where the format of remote diagnostic commands and diagnostic responses is in accordance with the remote command-line interface protocol. In one embodiment, the extension comprises a custom diagnostic “cluster server”. It should be understood that memory 302 is non-transitory, i.e., it excludes propagating signals, and that memory 302 could be incorporated into processor 300, for example, when processor 300 is, for example, an SoC. It should also be understood that once the processor-executable instructions are loaded into memory 302, processor 300 may be considered to be a specialized processor for performing functional and diagnostic operations of an electronic device.

Local wireless communication interface 304 is coupled to processor 300, comprising wireless communication circuitry for wirelessly sending and receiving both operational and diagnostic information to hub 208 and, in some embodiments, to other electronic devices in system 200. Such interface circuitry is well-known in the art, and may comprise one of a number of direct or mesh communication circuitry and protocols, such as a Zwave, Zwave Long Range or Zigbee, etc.

Hardwired interface 306 is coupled to processor 300, comprising a hardware connector or port, along with supporting electronic circuitry, for sending and receiving wired diagnostic commands and diagnostic responses directly to diagnostic computer system 214 when an electronic device is being developed or debugged in proximity to diagnostic computer system 214. Hardwired interface 306 may comprise a USB port, serial interface, or some other wired communication interface well-known in the art. During development or debugging, in one embodiment, an electronic device executes firmware that provides a command-line interface to diagnostic computer system 214. The command-line interface allows an engineer to send text-based diagnostic commands from diagnostic computer system 214 over a wire or data cable to hardware interface 306 and to receive diagnostic responses from an electronic device via hardware interface 306 over the wire or data cable. The firmware of an electronic device that provides a local command-line interface via hardwired interface 306 may also, in one embodiment, be the same or similar firmware that provides a remote command-line interface when an electronic device is remotely located from diagnostic computer system 214. In other embodiments, a first portion of firmware provides local diagnostics with diagnostic computer system 214 via hardwired interface 306 while a second portion of firmware provides remote diagnostics via local wireless communication interface 304. Hardware interface 306 may be disabled when an electronic device is deployed in the field in order to prevent tampering or misuse of an electronic device by an end-user.

Optional sensor 308 is coupled to processor 300, comprising circuitry and firmware for sensing a condition or status of an electronic sensor or its environment, or for allowing remote operation of an electronic appliance. For example, sensor 308 may comprise a magnetic reed switch, temperature sensor, light sensor, motion sensor, glass break sensor, thermostat, smart light bulb or switch, etc. Such sensors and controllers are well known in the art.

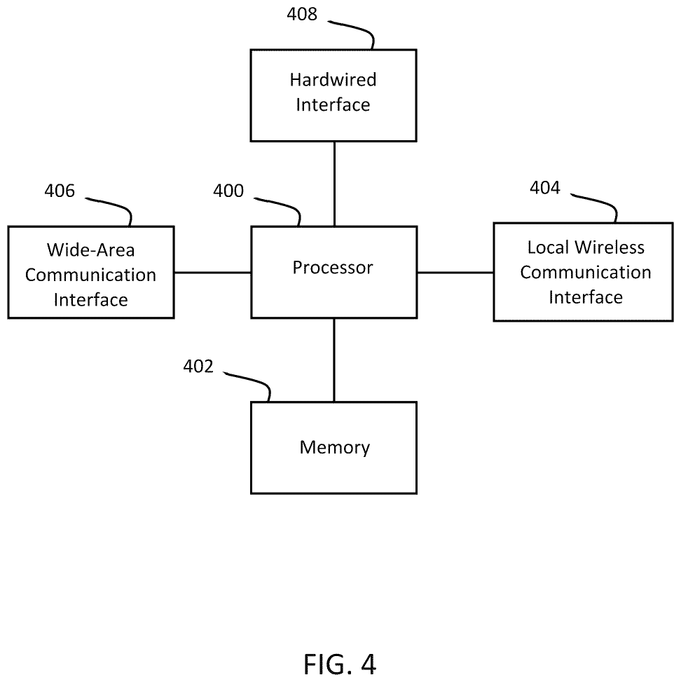

FIG. 4 is a functional block diagram of one embodiment of hub 208, configured to provide operational functionality to system 200 as well as remote diagnostic functionality to diagnostic computer system 214. FIG. 4 shows processor 400, memory 402, local wireless communication interface 404, wide-area communication interface 406 and hardwired interface 408. It should be understood that the functional blocks may be connected to one another in a variety of ways and that not all functional blocks are necessary for operation of hub 208 are shown (such as a power supply), for purposes of clarity.

Processor 400 is configured to provide operational functionality and diagnostic functionality of hub 208 by executing processor-executable instructions, i.e., firmware, stored in memory 402. Operational functionality comprises routing operational information between hub 208 and the electronic devices in system 200 and to communicate with remote entities over wide-area network 212, such as “back end” server for allowing users of system 200 to remotely monitor and/or control the electronic devices. Such operational information comprises operational commands and responses defined by a standardized, local-area wireless communication protocol for functional operation of system 200. For example, functional operation of system 200 may comprise functions of a security system, where the electronic devices comprise security sensors that monitor doors, windows or space in structure 210 and report status information to hub 208, acting as a security panel or security hub, configured to monitor the security sensors and generate security alerts when unauthorized entry is determined. As another example, functional operation of system 200 may comprise functions of a remote, home automation system, where various electronic devices may be monitored and controlled remotely, such as smart lightbulbs, smart thermostats, smart appliances, smart outlets, etc., where each of the electronic devices perform operational actions, such as turning a light on or off, adjusting a thermostat setting, turning a smart appliance off, turning a smart outlet on or off, respectively.

Diagnostic functionality of hub 208 comprises execution of a “terminal-like” program for providing a remote diagnostic interface to the electronic devices in system 200 for diagnostic computer system 214. The terminal-like program may be invoked by diagnostic computer system 214, which allows receipt of remote diagnostic commands from diagnostic computer system 214 via wide-area network 212, construction of encapsulated messages, transmitting the encapsulated messages to one or more of the electronic devices in system 200, receiving encapsulated messages from one or more of the electronic devices, extracting diagnostic responses from the encapsulated messages, constructing network-compatible response packets and sending the network-compatible response packets to diagnostic computer system 214 via wide-area network 212.

Processor 400 typically comprises one or more programmable microprocessors, microcomputers, microcontrollers, custom ASICs, System-on-Chips (SoCs), System-in-Packaging (SiP), or the like, and where two or more processors are used, each of the processors, either alone or in combination, may execute one or more of the processor-executable instructions that cause the processor to perform various functions. Processor 300 may be selected based on a variety of factors, including power-consumption, size, and cost.

Memory 402 is coupled to processor 400, comprising one or more information storage devices, such as RAM, ROM, flash memory, or some other type of electronic, optical, or mechanical memory device(s). Memory 402 is used to store processor-executable instructions for functional and diagnostic operation of hub 208, including the terminal-like program described above. In one embodiment, where the electronic devices in system 200 each utilize a cluster server, the processor-executable instructions may comprise a custom client application associated with the cluster servers to process remote diagnostic commands and diagnostic responses. Other information may be stored by memory 402 as well, such as diagnostic responses from any of the electronic devices and system 200, address information of the electronic devices and hub 208, etc.

It should be understood that memory 402 is non-transitory, i.e., it excludes propagating signals, and that memory 402 could be incorporated into processor 400, for example, when processor 400 is, for example, an SoC. It should also be understood that once the processor-executable instructions are loaded into memory 402, processor 400 may be considered to be a specialized processor for performing functional and diagnostic operations of hub 208.

Local wireless communication interface 404 is coupled to processor 400, comprising wireless communication circuitry for wirelessly communicating locally with the electronic devices in system 200, in accordance with a particular standardized, local-area wireless communication protocol used by of the 208 and the electronic devices. Local wireless communication interface 404 is capable of transmitting and receiving operational information as well as diagnostic commands and responses. Such interface circuitry is well-known in the art and may comprise one of a number of direct or mesh communication circuitry and protocols, such as a Zwave, Zwave Long Range or Zigbee circuitry and protocols.

Wide-area communication interface 406 is coupled to processor 400, comprising communication circuitry for communicating with devices outside of system 200, such as diagnostic computer system 214, over one or more wide-area networks 212, typically using a network-based communication protocol, such as TCP/IP. Such wide-area communication interface circuitry is well-known in the art, and may comprise Ethernet, Wi-Fi, etc. circuitry. In one embodiment, local wireless communication interface 404 and wide-area communication interface 406 utilize the same interface circuitry, such as when the electronic devices and hub 208 each utilize a Wi-Fi protocol for communicating with each other and remote entities.

Optional hardwired interface 408 is coupled to processor 400, comprising a physical connector or port, along with supporting electronic circuitry, for sending and receiving wired diagnostic commands and diagnostic responses directly to diagnostic computer system 214 when diagnostic computer system 214 is co-located with hub 208, coupled directly to hub 208 via a hardwired connection. Hardwired interface 408 may comprise a USB port, serial interface, or some other wired communication interface well-known in the art. Hub 208 may be configured to receive local diagnostic commands and send local diagnostic responses to diagnostic computer system 214 via hardwired interface 408, wide-area communication interface 406, or both.

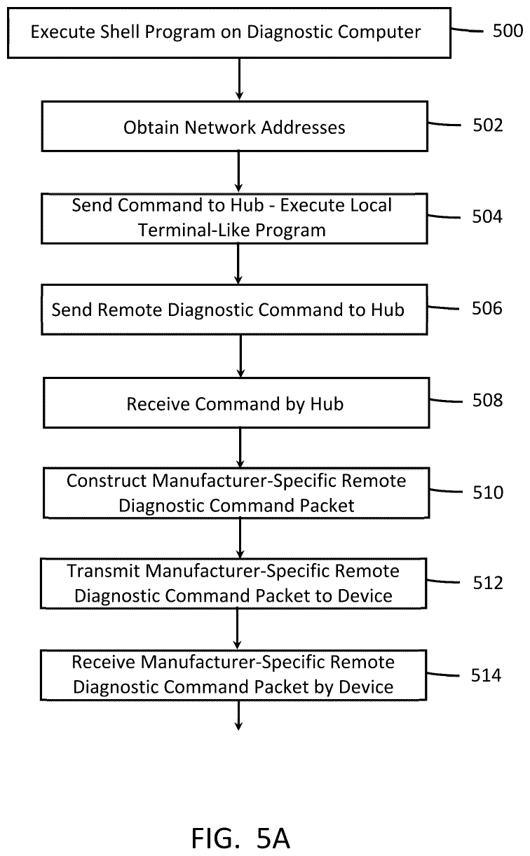

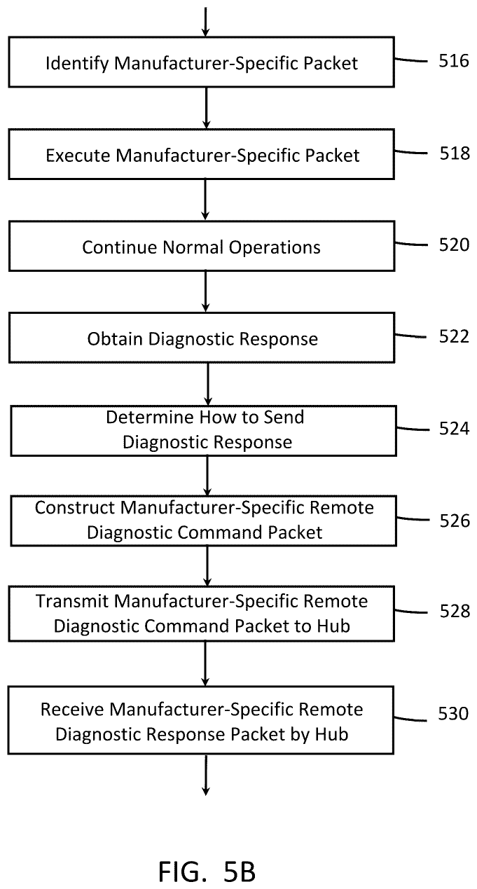

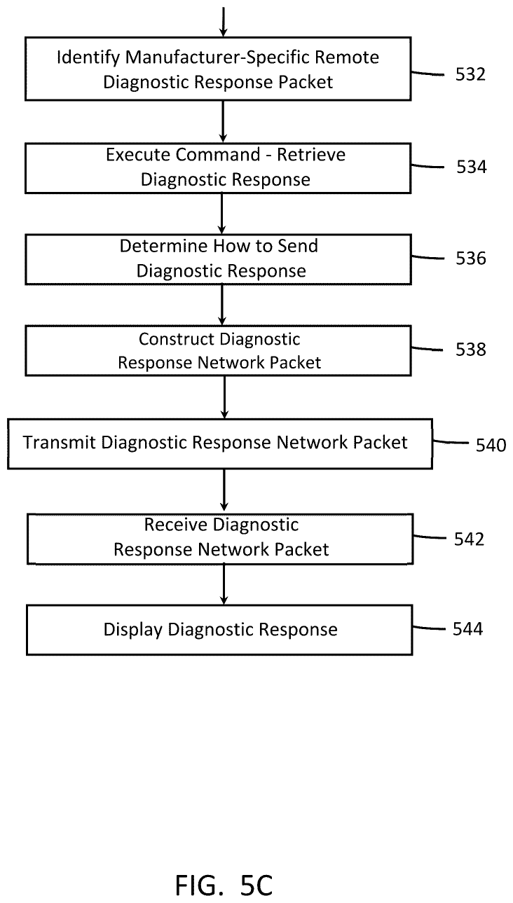

FIGS. 5A-5C represent a flow diagram illustrating one embodiment of a method for enabling remote development and/or diagnostics of the electronic devices of system 200. The method is described for a particular case where electronic device 202 is a security door sensor, where the security door sensor may be remotely diagnosed by diagnostic computer system 214. However, the method is not limited to such a particular electronic device. It should be understood that in some embodiments, not all of the method steps shown in FIGS. 5A-5C are performed and that the order in which the steps are performed may be different in other embodiments.

At step 500, in one embodiment, diagnostic computer system 214 is executing a standard secure shell client configured to interact with electronic device 202 via hardwire, as well as to provide a remote diagnostic interface to electronic device 202 over wide-area network 212. The shell client is well-known in the art, capable of local communication with electronic device when connected directly via a hardwire and/or securely communicating with hub 208 over wide-area network 212, such as OpenSSH, Telnet, etc. In one embodiment, the secure shell client is used to send text-based, remote diagnostic commands to electronic device 202 via network-based data packets in accordance with a communication protocol of wide-area network 212. The remote diagnostic commands are defined in accordance with an extension of a standardized, local-area wireless communication protocol used by hub 208 and electronic device 202.

At step 502, diagnostic computer system 214 may obtain a network address of hub 208 and each of the electronic devices in system 200, typically from a database controlled by a manufacturer of system 200.

At step 504, diagnostic computer system 214 may send a command to hub 208 over wide-area network 212, causing hub 208 to execute a custom “terminal-like” program that has been preloaded into hub 208 by a manufacturer of hub 208. The terminal-like program configures hub 208 to receive remote diagnostic commands over wide-area network 212, construct encapsulated messages containing the commands, sends the encapsulated messages to electronic device 102, receives encapsulated messages from electronic device 102 and constructs network-based diagnostic responses for transport over wide-area network to diagnostic computer system 214. In some embodiments, the terminal-like program may allow local diagnostics of electronic device 202, i.e., when diagnostic computer system 214 is co-located with hub 214 and coupled to hub 214 via hardwired interface 408. In some embodiments, the terminal-like program may utilize custom processor-executable instructions stored in memory 402 to construct encapsulated messages destined for electronic device 202 and to construct network-based responses from encapsulated messages received from electronic device 202, destined for diagnostic computer system 214 via wide-area network 212. In one embodiment, the custom processor-executable instructions comprise a portion of an extension to a standardized, local-area wireless communication protocol.

At step 506, a user of diagnostic computer system 214 may use the secure shell client operating on diagnostic computer system 214 to send a remote diagnostic command to electronic device 202 via wide-area network 212 and hub 208. The remote diagnostic command may comprise a custom, text-based diagnostic command defined by an extension of the standardized, local-area wireless communication protocol. In this case, the secure shell client receives the remote diagnostic command from a user of diagnostic computer system 214 and constructs a network-based remote diagnostic command packet for transport over wide-area network 212, such as one or more TCP/IP packets comprising the remote diagnostic command. Diagnostic computer system 214 then sends the network-based remote diagnostic command, addressed to hub 208 and identifying electronic device 202, to wide-area network 212 where it is routed to hub 208.

At step 508, processor 400 of hub 208 receives the network-based remote diagnostic command packet via wide-area communication interface 406 and evaluates the network-based remote diagnostic command packet using the terminal-like program to extract the remote diagnostic command and identify a target electronic device in system 200 based on an identification of a particular electronic device, in this example, electronic device 202.

At step 510, processor 400 constructs an encapsulated message in accordance with the standardized, local-area wireless communication protocol used by hub 208 and the electronic devices. The encapsulated message typically comprises a command field and a payload field, where the command field comprises an instruction in accordance with the standardized, local-area wireless communication protocol and an address of electronic device 202 in system 200, the instruction identifying the message as an encapsulated message and causing electronic device 202 to execute the remote diagnostic command contained in the payload.

At step 512, processor 400 causes the encapsulated message to be transmitted to electronic device 202 via wireless, local communication interface 406 in accordance with the standardized, local-area wireless communication protocol.

At step 514, processor 300 of electronic device 202 receives the encapsulated message via local wireless communication interface 304.

At step 516, processor 300 evaluates the encapsulated message and identifies it as an encapsulated message in accordance with the standardized, local-area wireless communication protocol. In one embodiment, electronic device 202 executes a custom, encapsulated diagnostic “cluster server” for executing remote diagnostic commands.

At step 518, processor 300 executes the remote diagnostic command in the payload in accordance with the extension of the standardized, local-area wireless communication protocol as if it was received locally via hardwired interface 306. The remote diagnostic command may comprise an instruction for processor 302 perform one or more diagnostic functions in accordance with the extension of the standard, local-area wireless communication protocol, such as to execute diagnostic code predefined by the extension, report a diagnostic status, condition, and/or attribute of electronic device 202 or its surrounding environment, etc. The remote diagnostic command may also comprise a “functional” command that causes processor 302 to perform actions normally performed during routine operation of electronic device 202. For example, a functional command may cause processor 302 to transmit a data packet to any other electronic device identified in a routing table of memory 302 and receive a response from the other electronic device(s). Functional, operational commands are typically defined by the standardized, local-area wireless communication protocol while diagnostic commands are defined by the extension.

In one embodiment, a remote diagnostic command may comprise an “interactive” command, which may place electronic device 202 into an “interactive” mode of operation, where processor 300 causes a stream of diagnostic data to be transmitted to hub 208. Functional operations of electronic device 202, and in some embodiments, further remote diagnostic commands, may be performed while diagnostic data is being streamed to hub 208. The diagnostic data may comprise data that is normally “printed” to hardwired interface 306 when electronic device 202 is directly coupled to diagnostic computer system 214. Such diagnostic data may comprise a state of electronic device 202, register values, counter values, etc., generated during normal operation of electronic device 202, and normally unavailable for use by other electronic devices or hub 208. In one embodiment, processor 300 generates a continuous stream of encapsulated messages, each comprising a particular portion of diagnostic data pertaining to electronic device 202 and/or other electronic devices in system 200. In one embodiment, processor 300 continues to generate and transmit encapsulated messages containing the diagnostic data until processor 300 receives an encapsulated message instructing processor 302 to stop sending the stream of encapsulated messages comprising the diagnostic data.

In one embodiment, in step 520, processor 300 may continue to operate normally during execution of remote diagnostic commands, additionally performing its normal, operational functions, i.e., receiving operational commands and providing operational responses to/from other electronic devices in system 200 and hub 208, in accordance with the standardized, local-area wireless communication protocol in use.

At step 522, processor 300 may obtain a diagnostic response in response to executing the remote diagnostic command. The diagnostic response may comprise a status, condition or attribute of electronic device 202, or another electronic device in network 200, a routing table of electronic device 202 or some other electronic device in system 200, an RSSI reading, or any other data relating to electronic device 202 or its surroundings, or other electronic devices in system 200.

At step 524, processor 300 may determine how to send the diagnostic response, either via local, wireless communication interface 304 or via hardwired interface 306, in an embodiment where electronic device 102 comprises both interfaces, and the I/O pin associated with hardwired interface 306 has not been disabled. Alternatively, the I/O pin may be disabled by default but re-enabled by processor 300 when processor 300 determines to send the diagnostic response via hardwired interface 306. Processor 300 may determine which way to send the diagnostic command based on how a diagnostic command associated with the diagnostic response was received. For example, if a diagnostic command was received via hardwired interface 306, processor 300 may cause the diagnostic response to be sent via hardwired interface 306. Similarly, if a diagnostic command was received remotely via local, wireless communication interface 304, processor 300 may cause the diagnostic response to be sent via local, wireless communication interface 304.

At step 526, processor 300 constructs either a diagnostic response message in accordance with either a local, wired protocol, such as USB, I2C, JTAG, etc., or the standardized, local-area wireless communication protocol. Construction of a diagnostic response in accordance with a local, wired protocol is well-known in the art. In the case of sending the diagnostic response via local, wireless communication interface 304, processor 300 constructs an encapsulated message in accordance with the standardized, local-area wireless communication protocol, comprising an instruction in accordance with the standardized, local-area wireless communication protocol identifying the message as an encapsulated message and to execute the diagnostic response in a payload section of the encapsulated message. In some embodiments, the encapsulated message comprises text-based diagnostic information related to electronic device 202 or other electronic devices in accordance with a remote command-line interface protocol defined by the extension, suitable for display by the secure shell client running on diagnostic computer system 214.

At step 528, processor 300 causes the encapsulated message to be transmitted to hub 208 via local wireless communication interface 304, in accordance with the standardized, local-area wireless communication protocol, or to hardwired interface 306, depending on the result of the determination above. In one embodiment, processor 300 causes transmission of a plurality of encapsulated messages containing diagnostic information while electronic device 202 is in the interactive mode.

At step 530, processor 400 of hub 208 receives the encapsulated message in accordance with the standardized, local-area wireless communication protocol.

At step 532, processor 400 evaluates the encapsulated message and determines, based on the command field, that the encapsulated message comprises an encapsulated message in accordance with the standard, local-area wireless communication protocol.

At step 534, in response to determining that encapsulated message comprises an encapsulated message, processor 400 executes the command in the header section in accordance with the standardized, local-area wireless communication protocol used by hub 208, instructing processor 400 to retrieve the diagnostic response from the payload section of the encapsulated message, and to execute the diagnostic response in accordance with the extension of the of the local-area wireless communication protocol.

At step 536, in one embodiment, processor 400 may determine how to send the diagnostic response to diagnostic computer system 214, either via wide-area communication interface 406 or hardwired interface 408. Processor 400 may determine which way to send the diagnostic response based on how a diagnostic command associated with the diagnostic response was received. For example, if a diagnostic command was received via hardwired interface 306, i.e., when diagnostic computer system 214 is co-located with hub 208 and coupled to hub 208 via a hardwire, processor 400 may cause the diagnostic response to be sent via hardwired interface 408. Similarly, if a diagnostic command was received remotely via wide-area communication interface 406, processor 400 may cause the diagnostic response to be sent via wide-area communication interface 406.

At step 538, processor 400 constructs a diagnostic response network packet for transport over wide-area network 212, such as one or more TCP/IP packets when processor 400 determines that the diagnostic response should be sent via wide-area communication interface 406. Alternatively, or in addition, processor 400 constructs a hardwired local diagnostic response packet containing the diagnostic response in accordance with the type of hardwired interface 408, such as UART, JTAG, I2C, USB, etc.

At step 540, processor 400 causes the diagnostic response network data packet to be sent to wide-area network 212 via wide-area communication interface 406, and/or the hardwired local diagnostic response packet to hardwired interface 408, as the case may be.

At step 542, diagnostic computer system 214 receives the diagnostic response, either over wide-area network 212 or via a hardwired interface of diagnostic computer system 214.

At step 544, diagnostic computer system 214 retrieves the diagnostic response from the diagnostic response network data packet, or the hardwired diagnostic response packet, and causes the diagnostic response to be displayed on a display screen of diagnostic computer system 214. In the case that a stream of diagnostic response network packets is received by diagnostic computer system 214, diagnostic computer system 214 displays the stream of diagnostic responses on the display screen. A user of diagnostic computer system 214 may then evaluate the diagnostic response data to continue developing or troubleshooting electronic device 202.

Although specific advantages have been enumerated above, various embodiments may include some, none, or all of the enumerated advantages.

Other technical advantages may become readily apparent to one of ordinary skill in the art after review of the foregoing figures and description.

It should be understood at the outset that, although exemplary embodiments are illustrated in the figures and described above, the principles of the present disclosure may be implemented using any number of techniques, whether currently known or not. The present disclosure should in no way be limited to the exemplary implementations and techniques illustrated in the drawings and described above.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. The article “a” means “one or more”.

To aid the Patent Office and any readers of any patent issued on this application in interpreting the claims appended hereto, there is no intention that any of the appended claims or claim elements invoke 35 U.S.C. 112 (f) unless the words “means for” or “step for” are explicitly used in the particular claim.

We claim:

1. A system for enabling remote diagnostics of electronic devices installed at an end-user location, comprising:
a hub located at the end-user location, communicably coupled to a computer system via a wide-area network, configured to receive a remote diagnostic command from the computer system over the wide-area network, the remote diagnostic command formed in accordance with an extension of a standardized, local-area wireless communication protocol, to construct a first encapsulated message in accordance with the standardized, local-area wireless communication protocol, the first encapsulated message comprising a command field that identifies the encapsulated message as an encapsulated message and a payload field in accordance with the standardized, local-area wireless communication protocol, the payload field comprising the remote diagnostic command, and to transmit the first encapsulated message to at least one of the electronic devices in accordance with the standardized, local-area wireless communication protocol; and
a first electronic device, configured to receive the first encapsulated message, to execute the remote diagnostic command in the payload in accordance with the extension of the standardized, local-area wireless communication protocol, to perform a diagnostic function associated with the remote diagnostic command in accordance with the extension, to obtain a diagnostic response from performing the diagnostic function, to construct a second encapsulated message comprising the diagnostic response and to transmit the second encapsulated message to the hub.

2. The system of claim 1, wherein the extension comprises a remote command-line interface protocol, wherein the remote diagnostic command comprises a text-based remote diagnostic command in accordance with the remote command-line interface protocol.

3. The system of claim 1, wherein the hub is further configured to receive the second encapsulated message, to construct a diagnostic response network packet comprising the diagnostic response and to send the diagnostic response network packet to the computer system via the wide-area network for display of the diagnostic response by the computer system.

4. The system of claim 1, wherein the extension comprises a remote command-line interface protocol, wherein the diagnostic response comprises a text-based diagnostic response in accordance with the remote command-line interface protocol.

5. The system of claim 1, wherein the remote diagnostic command comprises an interactive command, wherein the first electronic device is configured to stream diagnostic data to the hub in the form of a plurality of encapsulated messages, each of the plurality of encapsulated messages comprising a payload section comprising a portion of the diagnostic data, respectively.

6. The system of claim 5, wherein the first electronic device is further configured to receive a third encapsulated message, the third encapsulated message comprising a second remote diagnostic command to stop streaming the plurality of encapsulated messages to the hub and, in response, to stop streaming the plurality of encapsulated messages to the hub.

7. The system of claim 1, wherein the first electronic device is configured to execute operations inherent to a functionality of the first electronic device while also processing the remote diagnostic command.

8. The system of claim 5, wherein the first electronic device is further configured to receive a third encapsulated message while streaming the plurality of encapsulated messages to the hub, to execute a second remote diagnostic command in a second payload of the third encapsulated message while streaming the plurality of encapsulated messages, to obtain a second diagnostic response associated with the second remote diagnostic command and to transmit a fourth encapsulated message comprising the second diagnostic response as a third payload of the fourth encapsulated message among the plurality of encapsulated messages sent to the hub.

9. The system of claim 1, wherein the first electronic device comprises a hardwired interface, and the first electronic device is further configured to receive a hardwired diagnostic command from the hardwired interface, execute the hardwired diagnostic command, obtain a hardwired diagnostic response as a result of executing the hardwired diagnostic command and to send the hardwired diagnostic response to the hardwired interface.

10. The system of claim 1, wherein the remote diagnostic command is executable by the extension of the standardized, local-area wireless communication protocol but not executable by the standardized, local-area wireless communication protocol.

11. A method for enabling remote diagnostics of an electronic device installed at an end-user location, comprising:
receiving, by a hub located at the end-user location, a remote diagnostic command from a computer system over a wide-area network, the remote diagnostic command comprising command in accordance with an extension of a standardized, local-area wireless communication protocol, the standardized, local-area wireless communication protocol used for communications between the hub and the electronic device;
constructing, by the hub, a first encapsulated message in accordance with the standardized, local-area wireless communication protocol used by the hub to communicate with the first electronic device, the encapsulated message comprising the remote diagnostic command in a payload of the first encapsulated message;
transmitting, by the hub, the first encapsulated message to the first electronic device in accordance with the standardized, local-area wireless communication protocol;
receiving, by the first electronic device, the first encapsulated message;
executing the payload in accordance with the extension of the standardized, local-area wireless communication protocol;
performing a diagnostic function associated with the remote diagnostic command in association with the extension;
obtaining a diagnostic response from performing the diagnostic function;
constructing a second encapsulated message comprising the diagnostic response; and
transmitting the second encapsulated message to the hub.

12. The method of claim 11 wherein the extension comprises a remote command-line interface protocol, wherein the remote diagnostic command comprises a text-based remote diagnostic command in accordance with the remote command-line interface protocol.

13. The method of claim 11, further comprising:
receiving the second encapsulated message;
constructing a diagnostic response network packet comprising the diagnostic response; and
sending the diagnostic response network packet to the computer system via the wide-area network for display of the diagnostic response by the computer system.

14. The method of claim 11, wherein the extension comprises a remote command-line interface protocol, wherein the diagnostic response comprises a text-based diagnostic response in accordance with the remote command-line interface protocol.

15. The method of claim 11, wherein the remote diagnostic command comprises an interactive command, the method further comprising:
streaming diagnostic data to the hub in the form of a plurality of encapsulated messages, each of the plurality of encapsulated messages comprising a payload section comprising a portion of the diagnostic data, respectively.

16. The method of claim 15, further comprising:
receiving a second encapsulated message comprising a second remote diagnostic command to stop streaming the plurality of encapsulated messages; and
in response, stopping the streaming of the plurality of encapsulated messages.

17. The method of claim 11, further comprising:
executing operations inherent to a functionality of the first electronic device while also processing the remote diagnostic command.

18. The method of claim 15, further comprising:
receiving a third encapsulated message while streaming the plurality of encapsulated messages to the hub;
executing a second remote diagnostic command in a second payload of the third encapsulated message while streaming the plurality of encapsulated messages;
obtaining a second diagnostic response associated with the second remote diagnostic command; and
transmitting a fourth encapsulated message comprising the second diagnostic response as a third payload of the fourth encapsulated message among the plurality of encapsulated messages sent to the hub.

19. The method of claim 11, further comprising:
receiving a hardwired diagnostic command from a hardwired interface of the first electronic device;
executing the hardwired diagnostic command;
obtaining a hardwired diagnostic response as a result of executing the hardwired diagnostic command; and
sending the hardwired diagnostic response to the hardwired interface.

20. The method of claim 11, wherein the remote diagnostic command is executable by the extension of the standardized, local-area wireless communication protocol but not executable by the standardized, local-area wireless communication protocol.
